(19) United States
(12) Patent Application Publication
(10) Pub. No.: US 2011/0192828 A1
(43) Pub. Date: Aug. 11, 2011

(54) SYSTEM FOR MONITORING ARC WELDING PROCESSES AND CORRESPONDING MONITORING METHOD

(76) Inventors: Giuseppe D'angelo, Strada Torino (IT); Giorge Pasquettaz, Strada Torino (IT); Andrea Terreno, Strada Torino (IT)

(21) Appl. No.: 12/933,999

(22) PCT Filed: Feb. 10, 2010
(86) PCT No.: PCT/IB10/50610

§ 371 Date: Sep. 22, 2010

(30) Foreign Application Priority Data
May 22, 2009 (EP) 09425202.0

(51) Int. Cl. B23K 9/10

(52) U.S. Cl. 219/130.01

(57) ABSTRACT

Described herein is a system for monitoring arc-welding processes, comprising arc-voltage sensor means (21) and arc-current sensor means (22), means (23) for acquisition of voltage values (V) measured by said arc-voltage sensor means (21) and of current values (I) measured by said arc-current sensor means (22), and processing means (25) configured for processing said voltage values (V) and said current values (I) for calculating one or more vectors of time values (Tₒₙ[j]; T_{onV}[j), T_{onI}[j]) corresponding to a state of arc of the arc-welding process,

According to the invention, said processing means (25) are configured for executing the operations of:
calculating reference values (Ts_{supV}, Ts_{infV}, Ts_{supI}, Ts_{infI}) of arc time (Tₒₙ[j]; T_{onV}[j), T_{onI}[j]) via the steps of:
   calculating a statistical distribution of respective arc-time vectors (Tₒₙ[j]; T_{onV}[j), T_{onI}[j]) obtained from voltage values (V) and from current values (I), measured during execution of one or more reference welds; and
   calculating as reference values respective acceptability thresholds (Ts_{supV}, Ts_{infV}, Ts_{supI}, Ts_{infI}) corresponding to arc-time values (x) of the distribution whereby a probability (P(x)) of the distribution assumes a predetermined value (P_{inf}, Pₛᵤₚ);
performing monitoring of successive welds via the steps of:
   obtaining respective arc-time vectors (Tₒₙ[j]; T_{onV}[j), T_{onI}[j]) from voltage values (V) measured by said arc-voltage sensor means (21), and from current values (I) measured by said arc-current sensor means (22), corresponding to one or more of said successive welds; and
   performing a filtering on said arc-time vectors (Tₒₙ[j]; T_{onV}[j), T_{onI}[j]) to obtain corresponding filtered arc-time vectors (Tm[i]);
comparing said filtered arc-time vectors (Tm[i]) with said respective acceptability thresholds (Ts_{supV}, Ts_{infV}, Ts_{supI}, Ts_{infI}); and
identifying instabilities of the welding process (U_{V}, U_{I}, D) when said operation of comparison indicates that said filtered arc-time values (Tm[i]) are not comprised between said acceptability thresholds (Tsₛᵤₚ, Ts_{inf}).

The present invention relates to a system for monitoring arc-welding processes, which comprises arc-voltage sensor means and arc-current sensor means, means for acquisition of voltage values measured by said arc-voltage sensor means and of current values measured by said arc-current sensor means, and processing means configured for processing said voltage values and said current values for calculating one or more vectors of time values corresponding to a state of arc of the arc-welding process.

MIG (Metal-arc Inert Gas) or MAG (Metal-arc Active Gas) welding techniques envisage welding with metal under gas protection, respectively, under inert gas and under active gas. Said techniques have been known for several decades and go under the name of GNAW (Gas Metal Arc Welding). Said welding techniques have spread widely on account of the possibility of developing semi-automatic welding machines at a relatively low cost. The MIG/MAG welding method is a continuous-wire method, in which the protection of the weld puddle is ensured by a cover gas, which flows from the torch onto the piece to be welded. The metal of the wire, by melting, is transferred to the weld puddle according to three modalities: by short circuit, in drops, by spraying. In the first case, also referred to as “short arc”, the current that traverses the wire is not sufficiently high to bring it to the melting temperature; hence, the wire is in contact with the weld puddle, causing a short circuit between the two metals, which, by causing an increase in the current, melts the tip of the wire; i.e., the metal is not transferred through the arc. In the second case, the wire melts to form drops of a diameter greater than that of the electrode, which are transferred into the weld puddle basically by the force of gravity. In the case of spraying, the wire melts to form a large number of droplets, with currents higher than the ones required for transfer in drops.

Methods and systems are known for carrying out a monitoring during said arc-welding processes. Said processes in general envisage detection of the voltage and current from the arc-welding process and processing thereof. There are known, for instance, systems that monitor when the value of current exceeds a certain current threshold.

The U.S. Pat. No. 6,031,203 describes a method that envisages taking into account the arc and welding times deriving from the observation of voltage and current, calculating the standard deviation thereof. The stability of the weld is evaluated on the basis of a product of the standard deviation then compared to a reference value. It is also envisaged to calculate, in addition the voltage and current, a ratio between arc time and welding time and the standard deviation of said ratio. Said method proves as a whole complex for the operator to use, does not provide a possible operator with an immediately understandable representation of the possible defectiveness, and makes use of predetermined reference values.

The object of the present invention is to overcome all the aforesaid drawbacks.

With a view to achieving the above purpose, the subject of the invention is a system for monitoring arc-welding processes having the characteristics indicated at the start of the present description and characterized moreover in that said processing means are configured for executing the operations of:

calculating reference values of arc time obtained from voltage values and from current values measured during execution of one or more reference welds;

calculating, as said reference values, respective acceptability thresholds corresponding to arc-time values of the distribution whereby a probability of the distribution assumes a predetermined value; and

carrying out monitoring of successive welds via the steps of:
obtaining respective arc-time vectors to obtain corresponding filtered arc-time vectors;
comparing said filtered arc-time vectors with said respective acceptability thresholds; and
identifying the instabilities of the welding process when said operation of comparison indicates that said filtered arc-time values are not comprised within said acceptability thresholds.

In the preferred embodiment, said filtering comprises application of a median filter of rank that varies according to the desired sensitivity to defects.

Of course, the subject of the invention is also the method for monitoring arc-welding processes implemented by the system described above.

Further characteristics and advantages of the invention will emerge from the ensuing description with reference to the annexed drawings, which are provided purely by way of non-limiting example and in which:

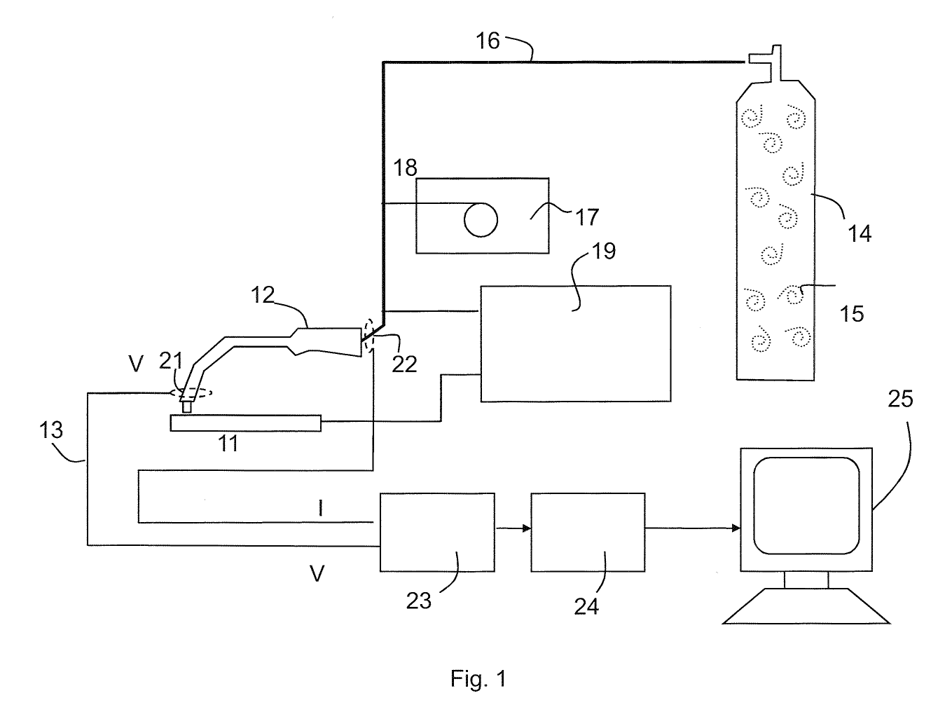

FIG. 1 is a schematic view of a system for monitoring arc-welding processes according to the invention;

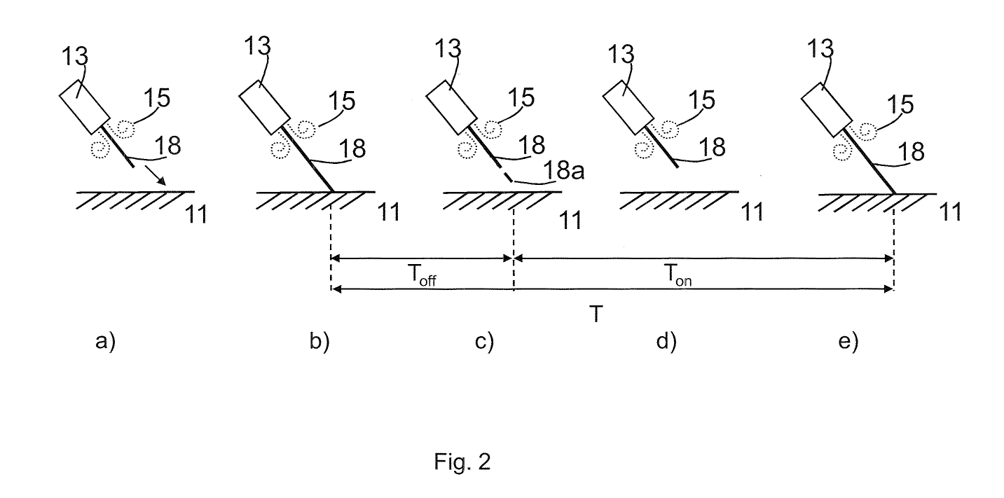

FIGS. 2a-2e illustrate steps of an example of arc-welding process monitored by the system according to the invention;

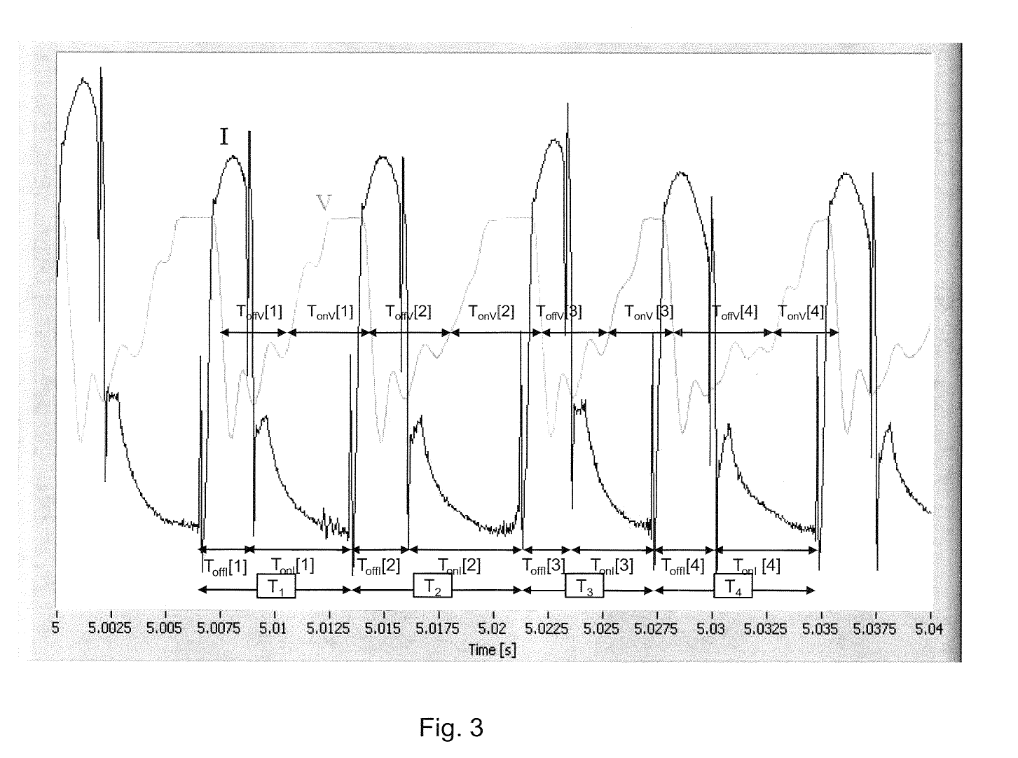

FIG. 3 shows a diagram of quantities acquired from the arc-welding process by the system according to the invention;

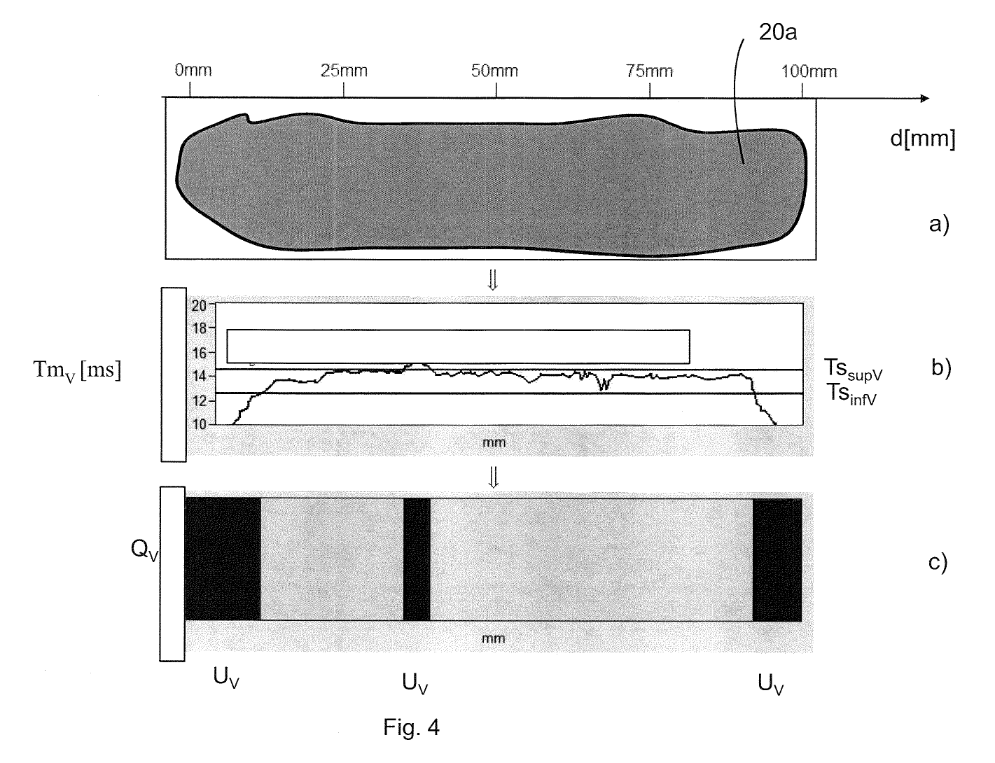

FIGS. 4a-4c show an example of acceptable weld and the corresponding diagrams illustrating operation of the system according to the invention;

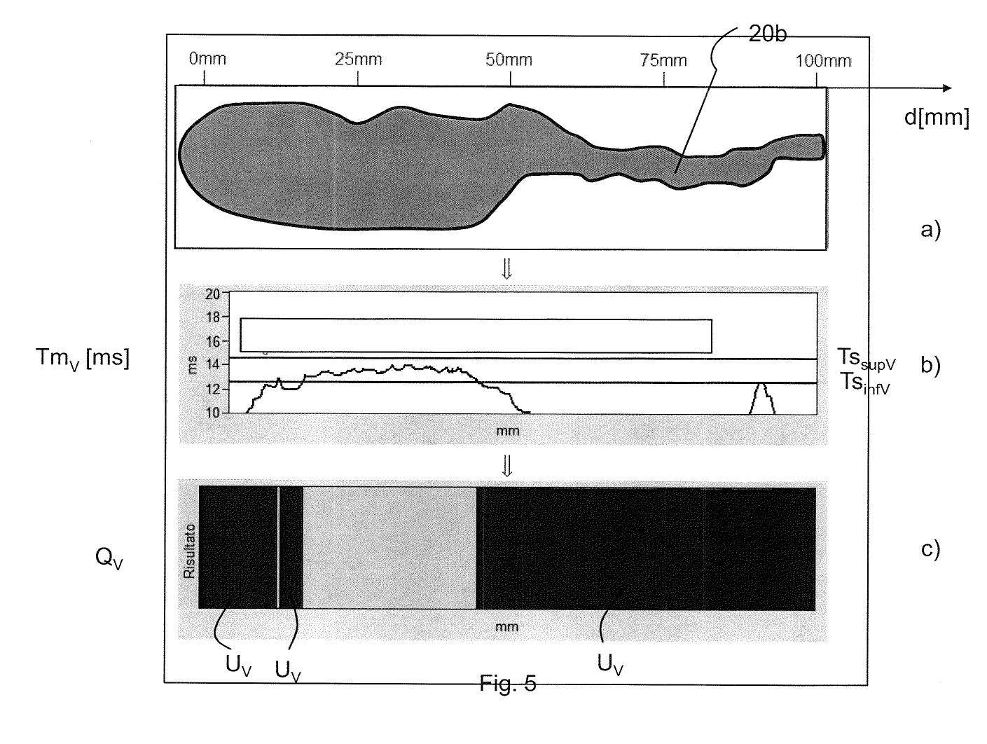

FIGS. 5a-5c show an example of non-acceptable weld and corresponding diagrams illustrating operation of the system according to the invention; and

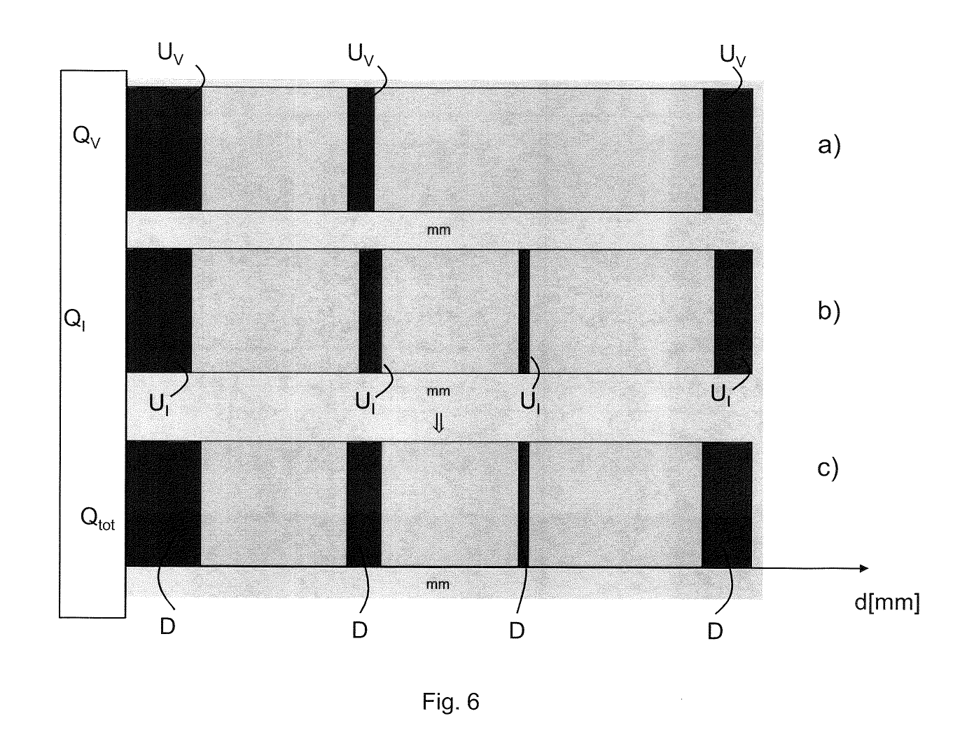

FIGS. 6a-6c show diagrams for identification of the welding defects used by the system according to the invention.

In brief, the system proposed envisages:

calculating a distribution of arc-time vectors corresponding to a reference weld and calculating acceptability thresholds of arc time imposing a value of probability on said distribution;

acquiring an arc-time vector for a weld to be monitored and estimating said arc times by applying a filtering;

comparing said filtered arc-time vector with said acceptability thresholds;

signalling a weld defect at arc-time values not comprised within said acceptability thresholds.

Represented in FIG. 1 is a block diagram of the system for monitoring arc-welding processes according to the invention, in which designated by the reference number 11 is a piece to be welded, on which the weld puddle is localized. Designated by the reference number 12 is a welding torch, which comprises a nozzle 13. Designated by 14 is a cylinder containing protection gas, which supplies a protection gas 15 through a duct 16 to the welding torch 12. Designated by 17 is an apparatus for unwinding the wire, said wire being designated by 18 and entering from the unwinding apparatus 17 into the duct 16 to be supplied to the welding torch 12. Moreover provided is an arc-current generator 19 connected to the welding torch 12 and to the piece to be welded 11. From the nozzle 13, as may be seen from FIGS. 2a-2e, protection gas 15 flows and also the welding wire 18 exits, said wire being set in contact, via a sliding-pad contact (not represented in the figures), with the electrical supply provided by the arc-current generator 19. According to the invention, provided, for example upstream of the nozzle 13, is a voltage sensor 21 for detecting the arc voltage on the welding wire 18, whilst an arc-current sensor 22, for example an amperometric clamp meter, for measuring the current on said welding wire 18 is provided on board the arc-current generator 19. The arc-voltage sensor 21 and the arc-current sensor 22 supply their outputs, respectively, a voltage value V and a current value I, to an acquisition card 23, for example a 24-bit, 32-kHz card. The acquisition card 23 supplies said current value I and said voltage value V, after having acquired them, to an interfacing card 24 (for example a digital card of a CAN-bus type) to the production line on which the welding processes are being carried out, said production line being represented in FIG. 1 by a processor 25, which evaluates said current value I and voltage value V and then possibly manages the production line on the basis of information on the quality of the arc-welding process that is obtained from said current value I and voltage value V.

With reference to FIGS. 2a-2e, in order to illustrate the steps and the time instants that are important for the system and the method according to the invention, the method of short-arc welding will now be briefly illustrated. The working principle of the process of analysis of the quality of the welds derives in fact from analysis of the short-arc arc-welding process.

FIG. 2a is consequently a very schematic representation of the nozzle 13 of the welding torch 12 from which the protection gas 15 and the welding wire 18 exit. In the step illustrated in FIG. 2a, the wire 18 is represented as it is advancing towards the piece 11 under the action of the unwinding apparatus 17. In the step illustrated in FIG. 2b, the wire 18 is in contact with the piece 11 and sets up a short circuit therewith, i.e., with the weld puddle. FIG. 2c represents the step of detachment of a drop 18a from the wire 18, FIG. 2d then represents the welding wire 18 during subsequent advance towards the piece 11, FIG. 2e represents the welding wire 18 in a subsequent state of short-circuit with the piece 11. Between the steps represented in FIGS. 2b and 2d, the process is in an arc condition, and an arc time or hot time Tₒₙ is hence indicated, i.e., the time taken from the moment when the drop 18a of the welding wire 18 starts to detach from the wire 18 to the moment when it melts in the weld puddle on the piece 11 and a new drop is generated by the short circuit between the wire 18 and the piece 11. Said short circuit pre-announces, in fact, detachment of a new drop 18a from the wire 18. Also indicated in FIG. 2 is a total period T of the welding process, calculated between the two short-circuit states, and a cold time T_{off} complementary to the hot time Tₒₙ, in the time interval between the short circuit (FIG. 2a) and the detachment of the drop. It is hence clear how an analysis of the succession of hot times or arc times Tₒₙ will enable evaluation of the frequency of detachment of the drops. In the case where the welding process is stable, also the frequency of detachment of the drops is regular and constant, whilst in the case of welding with defectiveness the process of detachment of the drops does not present a regular and constant frequency.

The system according to the invention is configured for carrying out a comparison of the times obtained from the signals acquired by the arc-welding process with thresholds extracted from a reference signal.

FIG. 3 shows the time plot of values of arc current I and arc voltage V acquired during a welding process. In said plot, even though excursions due to transients are present, it is possible to identify, on the basis of what has been said as regards the process described in FIG. 2, a substantially pulsed or square-wave evolution, with the total period T, the hot time Tₒₙ and the complementary cold time T_{off}. As may be appreciated from FIG. 3, said times, which are of the order of tens of milliseconds, are not always constant, but are variable from drop to drop.

Consequently, the monitoring system according to the invention is configured for carrying out an operation of generation of a reference signal, which envisages making, via the arc-welding process, one or more welding beads, and at the same time acquiring via the voltage sensor 21 and current sensor 22 the corresponding arc voltage V and arc current I.

For each weld bead acquired, measured by the computer 25 are the hot times Tₒₙ corresponding to the time of detachment of the drop 18a, as illustrated with reference to FIGS. 2a-2e. A weld bead usually envisages detachment of a number of drops from the wire 18 and hence in general there will be a vector of hot times Tₒₙ for each weld bead. Indicated in FIG. 3 are in particular the hot times corresponding to four successive drops T_{onV}[1], T_{onV}[2], T_{onV}[3], T_{onV}[4] that contribute to composing said hot-time vector. In general a hot-time vector is obtained, with a much greater number of values, T_{onV}[j], where j is the index of the vector and the subscript V indicates that the times are evaluated starting from the voltage values V. A respective hot-time vector T_{onI}[j] is also obtained on the basis of the current values I. Shown in FIG. 3 are both the times deriving from the current values I and the times deriving from the voltage values V. The monitoring system according to the invention processes, in the computer 25, said hot-time vectors T_{onV}[j] or T_{onI}[j], or else a number of hot-time vectors associated to a number of weld beads produced by way of reference, for calculating a normal cumulative distribution function (CDF) thereof. Said normal cumulative distribution function supplies a mean value μ of the hot times T_{onV}[j] or T_{onI}[j] measured, as well as a standard deviation σ of the hot times T_{onV}[j] or T_{onI}[j] measured.

In the ensuing treatment, reference will be made for reasons of simplicity to the hot-time vector Tₒₙ[j] alone, without specifying whether it derives from the voltage values or from the current values.

The system according to the invention is then configured for continuing processing in the computer 25 and identifying acceptability-threshold values Ts for the hot time Tₒₙ, i.e., values beyond which the times and frequencies that derive therefrom are to be considered excessively irregular to be able to guarantee a good-quality weld, on the basis of the distribution function of the normal cumulative distribution, i.e., the probability P(x) of the distribution:

$$P ( x ) = \frac{1}{2} ( 1 + erf ( \frac{x - μ}{σ \sqrt{2}} ) ) \qquad ( 1 )$$

The system comprises calculation of the value of the variable x of the distribution whereby said probability P(x) assumes a pre-determined value, which can possibly be set by the operator or by a further control module. The value of the variable x found corresponds to the acceptability threshold Ts for the arc times; i.e., the variable x identifies arc-time values of the distribution whereby the probability P(x) of the distribution assumes a pre-determined value. Said pre-determined value of probability P(x) is proportional to a value of sensitivity Sens. Setting, for example, the value of sensitivity Sens equal to 90, the system obtains automatically the lower acceptability threshold Ts_{inf} and upper acceptability threshold Tsₛᵤₚ, according to the relations given below, which determine the lower probability P_{inf}(x) and the higher probability Pₛᵤₚ(x):

$${P}_{inf} ( x ) = 1 - \frac{Sens}{100} ⇒ {Ts}_{inf} \\ {P}_{sup} ( x ) = \frac{Sens}{100} ⇒ {Ts}_{sup} \qquad ( 2 )$$

From the above equations, it is clear that if, for example, the value of sensitivity Sens is set at 90, this corresponds to seeking a probability of 90%. It is possible to reduce or increase said sensitivity Sens to render the system more or less sensitive to the variations of the value of the hot times Tₒₙ obtained from the values of voltage V and current I.

As has been mentioned, the above treatment does not take into account whether voltage or current values are being processed, but, in greater detail, the system obtains, once the desired sensitivity Sens has been set, a lower acceptability threshold Ts_{inf V} and an upper acceptability threshold Ts_{sup V} from the hot-time vector T_{onV}[j] obtained from voltage values, and another lower acceptability threshold Ts_{inf I} and upper acceptability threshold Ts_{sup I} from the hot-time vector T_{onI}[j] obtained from current values.

Consequently, the system according to the invention obtains the lower acceptability threshold Ts_{inf} and upper acceptability threshold Tsₛᵤₚ, more specifically, as has just been mentioned, two pairs of thresholds for the voltage and for the current, from the data coming from the execution of one or more weld beads, made, for example, at the start of the production cycle. Next, the system according to the invention is configured for monitoring the arc-welding process by processing, on the computer 25 at the end of formation of a weld bead, the respective values of arc voltage V and arc current I acquired, measuring the regularity of the hot times Tₒₙ obtained from said values, i.e., the regularity of the time taken by the drop of metal 18a originating from the wire 18 to detach, melt, and drop into the weld puddle, up to the next restoration of the short-circuit state, i.e., cessation of the arc step. FIG. 2 (already described) provides the example of how a measurement of the hot time Tₒₙ occurs to obtain a hot-time vector Tₒₙ[j] corresponding to a stretch of the weld bead. Once said hot-time vector Tₒₙ[j] corresponding to a weld bead is available, it is then envisaged to obtain an estimate of the hot times, applying a median filter of rank that varies according to the sensitivity of the defects that are to be taken into account, to obtain a filtered hot-time or arc-time vector Tm[i].

The filter can also assume the closed form:

Tm[i]=median filter(Jᵢ) (3)

where Jᵢ is a subset of the input vector, i.e., the hot-time vector Tₒₙ[j]:

Jᵢ={Tₒₙ_{_{i−N}},Tₒₙ_{_{i−N+1}} . . . , Tₒₙ_{_{i−1}},Tₒₙ_{ᵢ},Tₒₙ_{ᵢ₊₁} . . . , Tₒₙ_{_{i+N−1}},Tₒₙ_{_{i+N}}},

N is the rank of the filter, which is inversely proportional to the sensitivity of the filter: the smaller the value of the rank N, the more the system is rendered sensitive to the minor impurities present in the weld bead. Conversely, the higher the value, the more the fast variations of the measurements of the hot times Ton are filtered, and hence the system is rendered less sensitive.

The index j is the index of the vector of hot-time values Tₒₙ[j] acquired for a weld bead. The index i is the index of the filtered hot-time or arc-time vector Tm[i].

The system according to the invention is configured for identifying, via processing in the computer 25, a weld defect by carrying out a comparison between the filtered arc-time vector and the acceptability thresholds. Where said operation of comparison indicates that said filtered arc-time values are not comprised between said acceptability threshold, a weld defect is in general signalled.

More specifically, according to the invention, there is envisaged calculation of a filtered hot-time vector Tm_{V}[i] on the basis of the hot-time vector T_{onV}[j] from voltage values and a respective filtered hot-time vector Tm_{I}[i] on the basis of the hot-time vector T_{onI}[j] from current values, which are compared with the respective lower acceptability threshold and upper acceptability threshold, Ts_{inf V} and Ts_{sup V} for the vector Tm_{V}[i], Ts_{inf I} and Ts_{sup I} for the vector Tm_{I}[i].

FIGS. 4a-4c give an example of a good-quality weld bead 20a, in which said filtered hot-time vector Tm[i], specifically the filtered hot-time vector Tm_{V}[i] obtained from the voltage values V, falls within the threshold set. Shown in FIG. 4a is a schematic representation of the weld bead 20a, which develops substantially along an axis that represents the length d of the weld bead. The bead 20a has, by way of example, an overall length of 100 mm. Given in FIG. 4b is the filtered hot-time vector Tm_{V}[i] according to the length d, and given in FIG. 4c is a quality signal Q_{V}. Instead, FIGS. 5a-5c likewise give an example of poor-quality weld bead 20b. It may be noted how, after the first half of the bead 20b there is a complete absence of welding, which emerges from the irregularity in detachment of the weld drops and can be deduced from the fact that values of the filtered hot-time vector Tm_{V}[i] lie outside the range identified by the lower acceptability threshold Ts_{inf V} and the upper acceptability threshold Ts_{sup V}. Similar results are obtained by considering the current values I. In each of the two cases illustrated one in FIG. 4c and one in FIG. 5c the respective quality signal Q_{V} is shown, which is substantially a signal that assumes two levels on the basis of the result of the operation of comparison with the lower acceptability threshold Ts_{inf V} and upper acceptability threshold Ts_{sup V}, as a function of the length d of the weld bead. In said FIGS. 4c and 5c, said levels are identified and appear as bands corresponding to regions or intervals of the weld along the axis of the length d, representing with darker bands (which may also be coloured bands, for example red ones) the regions where the hot time T_{onV} falls below the lower threshold Ts_{inf V} or above the upper acceptability threshold Ts_{sup V} and hence here a process instability is identified, designated by U_{V} (or U_{I} if current values I have been considered, and hence a corresponding quality signal Q_{I}). Lighter bands (which may also be coloured bands, for example green ones) identify the regions where, instead, the process is considered stable, in so far as the values of the hot time T_{onV} are comprised between the lower acceptability threshold Ts_{inf V} and the upper acceptability threshold Ts_{sup V}.

Once evaluation the filtered hot-time vector Tm_{V}[i] from voltage values V and of the filtered hot-time vector Tm_{I}[i] from current values I has been completed, two corresponding quality signals Q_{V} and Q_{I}, respectively, obtained are combined with one another to determine a total quality signal Qₜₒₜ that adds together and superimposes the respective areas of process instability U_{V} and U_{I} in the different regions of the weld to identify the presence of a weld defect D in a region of the weld as a function of the length d. FIGS. 6a-6c are examples of said type of evaluation, FIG. 6a indicating the intervals of process instability U_{V} identified via the voltage values V. FIG. 6b indicating the intervals of process instability U_{I} identified via the current values, and FIG. 6c indicating the intervals of weld defect D deriving from the combination of the intervals of process instability of voltage U_{V} and current U_{I}. The diagram of FIGS. 6a-6c, in particular the diagram of FIG. 6c can constitute a graphic output displayed on the computer 25 for the operator. Identification of the presence of a number of defects generates a non-coherent global evaluation of the weld.

According to a preferred version of the system according to the invention, it is envisaged in processing of the voltage values V and current values I to neglect the values corresponding to the stretch of ignition and extinction of the arc (for example, the first 15 mm and last 15 mm of the bead). In the resulting central part of the weld bead the monitoring system is preferably configured for applying, for example through processing on the computer 25, the following criteria of signalling of the defects:
if consecutive defects are identified in an interval that covers a given length of the weld bead, for example, at least 5 mm, the system warns, via a purposely provided signalling device, such as a lamp or siren or other signalling means that can be controlled by the computer 25, that the weld has a fault;
if defects, which can also be non consecutive, are identified in intervals having a total length greater in percentage terms than a given percentage of the length of the weld bead, for example 30%, defectiveness (even non-consecutive), it signals the presence of a fault;
in the other cases, the monitoring system judges the weld as being of “acceptable” quality: it does not present either consecutive defects beyond 5 mm, or too many isolated defects (beyond 30% of the length of the bead).

Thanks to the characteristics that have been indicated above, the system according to the invention provides a monitoring which supplies a reference linked to the conditions of the welding process, given that the acceptability thresholds derive from a statistical evaluation of parameters acquired. Advantageously, the system according to the invention combines the possibility of setting in a simple way the sensitivity of the acceptability thresholds for the arc times, via the simple setting of the desired probability for the variable arc time, with the possibility of adjusting in a simple way the sensitivity to the rapidity of the oscillations of the arc time in the specific process.

The result is a particularly simple system that is readily understandable for the operator as regards setting thereof in so far as the system tends to produce semiautomatically thresholds with time values well correlated to the type of welding process in progress in a given production cycle, substantially determining a working point in terms of arc-time values of the monitoring system.

The adoption of a method that envisages calculating a distribution of the arc times and obtaining therefrom the thresholds by setting values that the distribution probability must assume moreover involves specific advantages as compared to the use of other techniques that use, for example, the mean value of the data vector, the standard deviation, or the sum of the mean value and of the deviation. The use of the distribution advantageously produces in fact thresholds that are more stable in regard to process instabilities, which determine a range of acceptability of the arc time that is narrower (approximately 1 ms in the case of the example).

In this context, the control of the sensitivity to the defects of the filtering envisages a fine adjustment around said working point prior to comparison with the acceptability threshold, which enables management of the rapidity of the variations of the arc times from one drop to the other during the welding process. Said control of the sensitivity to defects advantageously co-operates with the settings of sensitivity of the step of calculation of the reference acceptability threshold for establishing in a simple and manageable way the overall sensitivity of the monitoring system in regard to defects.

Of course, without prejudice to the principle of the invention, the details of implementation and the embodiments may vary widely with respect to what has been described and illustrated herein purely by way of example, without thereby departing from the scope of the present invention.

1. A system for monitoring arc-welding processes, comprising arc-voltage sensor means (21) and arc-current sensor means (22), means (23) for acquisition of voltage values (V) measured by said arc-voltage sensor means (21) and of current values (I) measured by said arc-current sensor means (22), and processing means (25) configured for processing said voltage values (V) and said current values (I) for calculating one or more vectors of time values (Tₒₙ[j]; T_{onV}[j), T_{onI}[j]) corresponding to a state of arc of the arc-welding process,
said system being characterized in that:
said processing means (25) are configured for executing the operations of:
calculating reference values (Ts_{supV}, Ts_{infV}, Ts_{supI}, Ts_{infI}) of arc time (Tₒₙ[j]; T_{onV}[j), T_{onI}[j]) via the steps of:
calculating a statistical distribution of respective arc-time vectors (Tₒₙ[j]; T_{onV}[j), T_{onI}[j]) obtained from voltage values (V) and from current values (I), measured during execution of one or more reference welds; and
calculating as reference values respective acceptability thresholds (Ts_{supV}, Ts_{infV}, Ts_{supI}, Ts_{infI}) corresponding to arc-time values (x) of the distribution whereby a probability (P(x)) of the distribution assumes a predetermined value (P_{inf}, Pₛᵤₚ);
performing monitoring of successive welds via the steps of:
obtaining respective arc-time vectors (Tₒₙ[j]; T_{onV}[j), T_{onI}[j]) from voltage values (V) measured by said arc-voltage sensor means (21), and from current values (I) measured by said arc-current sensor means (22), corresponding to one or more of said successive welds; and
performing a filtering on said arc-time vectors (Tₒₙ[j]; T_{onV}[j), T_{onI}[j]) to obtain corresponding filtered arc-time vectors (Tm[i]);
comparing said filtered arc-time vectors (Tm[i]) with said respective acceptability thresholds (Ts_{supV}, Ts_{infV}, Ts_{supI}, Ts_{infI}); and
identifying instabilities of the welding process (U_{V}, U_{I}, D) when said operation of comparison indicates that said filtered arc-time values (Tm[i]) are not comprised between said acceptability thresholds (Tsₛᵤₚ, Ts_{inf}).

2. The system according to claim 1, characterized in that said filtering comprises application of a filtering of rank (N) that varies according to the desired sensitivity to defects.

3. The system according to claim 2, characterized in that said filtering comprises application of a median filter of variable rank.

4. The system according to claim 1, characterized in that said processing means (25) are configured for executing said operation of comparison and identification of the instability of the welding process (U_{V}, U_{I}, D) as a function of the length (d) of the weld (20a, 20b).

5. The system according to claim 1, characterized in that said processing means (25) are configured for identifying intervals of arc-voltage instability (U_{V}) by comparing the filtered arc-time vector (Tm_{V}) obtained from the arc-voltage values (V) with the respective acceptability thresholds (Ts_{supV}, Ts_{infV}) and identifying intervals of arc-current instability (U_{I}) by comparing a filtered arc-time vector (Tm_{I}) obtained from arc-current values (I) with the respective acceptability thresholds (Ts_{supV}, Ts_{infV}),
said processing means (25) being moreover configured for identifying a weld defect (D) in regions of the weld obtained by the superposition of intervals of arc-voltage instability (U_{V}) and of intervals of arc-current instability (U_{I}).

6. The system according to claim 4, characterized in that said processing means (25) are configured for generating, on the basis of said operation of comparison, weld-quality signals (Q_{V}, Q_{I}, Qₜₒₜ) with two levels, which identify, respectively, the instability intervals (U_{V}, U_{I}, D), in which said filtered arc-time values (Tm[i]) are not comprised between said acceptability thresholds (Tsₛᵤₚ, Ts_{inf}) and stability intervals, where said filtered arc-time values (Tm[i]) are comprised between said acceptability thresholds (Tsₛᵤₚ, Ts_{inf}).

7. The system according to claim 6, characterized in that said processing means (25) are configured for displaying (25), via a display of bands of different intensity or colour, associated, respectively, to said levels, weld-quality signals (Q_{V}, Q_{I}, Qₜₒₜ).

8. The system according to claim 1, characterized in that said distribution is a normal cumulative distribution.

9. The system according to claim 1, characterized in that it comprises setting a value of desired sensitivity (Sens) for regulating said predetermined value (P_{inf}, Pₛᵤₚ) assumed by said probability (P(x)) of the distribution for calculation of the acceptability thresholds (Ts_{supV}, Ts_{infV}, Ts_{supI}, Ts_{infI}).

10. The system according to claim 1, characterized in that said operation of processing arc-voltage values (21) and arc-current values (22) comprises neglecting values corresponding to the stretch of ignition and extinction of the arc.

11. The system according to claim 1, characterized in that said processing means (25) are configured for signalling a fault if said operation of identification of welding defects (D) identifies consecutive defects in an interval that covers a given length of the weld bead.

12. The system according to claim 1, characterized in that said processing means (25) are configured for signalling a fault if said operation of identification of welding defects (D) identifies even non-consecutive defects in intervals of total length greater in percentage terms than a given percentage of the length of the weld bead (20a, 20b).

13. The system according to claim 1, characterized in that it comprises interfacing means (24), in particular operating according to the CAN-bus protocol, for interfacing said acquisition means (23) with said processing means (25), said processing means (25) being operatively connected for controlling it to a production line on which the welding processes are executed on the basis of said instability of the welding process (U_{V}, U_{I}, D) identified from the current values (I) and voltage values (V).

14. A method for monitoring arc-welding processes, comprising the operations executed via a system according to claim 1.
